(19) United States
(12) Patent Application Publication
(10) Pub. No.: US 2003/0018952 A1
(43) Pub. Date: Jan. 23, 2003

(54) System and method to estimate resource usage for a software development project

(76) Inventor: William H. Roetzheim, Jamul, CA (US)

Correspondence Address: William J. Kolegraff, 3119 Turnberry Way, Jamul, CA, 91935, US

(21) Appl. No.: 09/904,644

(22) Filed: Jul. 13, 2001

(51) Int. Cl. G06F 9/44

(52) U.S. Cl. 717/101

(57) ABSTRACT

An adaptable resource estimating system operates on a computer system and uses a highly flexible parametric rule. The parametric rule receives values, including values relating to each of a software project type, a software lifecycle, and a software standard. More particularly, a user chooses a software project type from a set of available software project types, a software lifecycle from a set of available software lifecycles, and a software standard from a set of available software standards. The chosen project type, lifecycle, and standard may be related or unrelated, and may be changed independent of the others. Responsive to choosing the project type, the lifecycle, and the standard, the adaptable resource estimating system sets values in the parametric rule. The parametric rule executes and resource estimates are prepared regarding resource utilization for the particular chosen project type, lifecycle, and standard.

### FIELD

The field of the present intention is estimating software for operation on a computer system. More particularly, the present intention relates to a software system for estimating resource usage for a software development project.

### BACKGROUND

Developing a complex software application typically requires initiating and managing a substantial software development project. Unfortunately, software development projects often consume considerable resources during development, deployment, and maintenance. If the software development project consumes more resources than expected, which is often the case, the software development project may exceed its budget, take much longer than expected, or produce a substandard product having excessive defects. Accordingly, it is highly advantageous to accurately predict the level of resources that will be consumed in a particular software development project.

In predicting resource utilization, a software manager often relies upon a resource estimating tool, such as a resource estimating software application. Such resource estimating tools are well known and are able to provided software managers with considerable assistance in managing a software development project. One particular useful resource estimating tool is a resource estimating tool utilizing parametric algorithms. To use these parametric algorithms or rules, several aspects of the software development project are appraised and valued. For example, a software manager may subjectively assess the experience level of the project development team, and assign a number or other value to the assessment. These assigned values are then used to set or modify variables and parameters in the parametric algorithm.

Several parametric algorithms or equations have been developed by academics, researchers, and those in industry. Such parametric equations enable a software manager to easily make modifications to a software development project and quickly estimate how such a change affects resource utilization.

A typical parametric equation has several cost based and noncost based variables. Sometimes, the parametric equation will use a different set of variables depending upon the particular project type for the project development project. In applying the parametric equation, the resource estimating system applies the value of the various variables in the equation and calculates a resource result for the software manager. Typically, such an output may estimate the amount effort required for the software development program, estimate a schedule for the project, estimate defects in the software, or provide a costing estimate. Since the resource estimating system is dependent on a parametric equation, the values set for the parameters in the equation are critical to the correctness of the estimations.

One of the more critical inputs to the parametric equation are values for variables related to a project type. For example, a military project type is likely to provide very different value inputs to the parametric equation then the values for a commercial project type. To assist the software manager in more accurately and efficiently providing input to the parametric equations, known resource estimating systems often have many project types predefined and available for selection. For example, it would not be unusual to find a resource estimating system with 30 or more project types defined. In this regard, project types may be defined with a fair degree of granularity. In such a manner, one project type may be defined for an Internet business to business (B to B) site, while another project type may be defined for a business to commercial (B to C) site. Even though these software types at first may seem highly related, they actually may have considerably different resource requirements and therefore each project type would provide different value inputs to the parametric equation.

Generally, each project type also has a related software lifecycle and a related software standard. In a known estimating system, a software lifecycle typically uses the results from the parametric equation to more fully define a work breakdown structure. In such a typical parametric resource estimating system, the software lifecycle related with the project type defines a detailed task or action list, typically with a cost and time associated with each task. In a similar manner, each project type in a known estimating system generally has an associated software standard. The software standard generally defines documentation required during the various phases of the software development project. For example, the software standard could define architecture documents required during development, training manuals needed during deployment, and update manuals required for periodic maintenance releases. In a particular example, a military project type has typically required compliance with a military software standard such as MIL-STD498. This standard provides a highly detailed list of documents and other deliverables that the software developer must deliver to the military.

As generally described, the software manager generally uses the known parametric estimating system by first selecting a project type. In response, the parametric resource estimating system generates preliminary resource usage information. The known parametric resource estimating system then applies the software lifecycle and software standard for the selected project type. In this regard, the estimating system is able to generate a cost estimate, a detailed schedule, and comprehensive list of required documents.

It will be appreciated that the known parametric estimating system may also accept other variable input information. For example, the parametric estimating system may accept a sizing metric related to the software development project. Often, such a sizing metric is expressed in terms of thousands of lines of code, or KSLOCs. Several different sizing metrics are known, such as estimating size based on the function points in the software project, estimating size based on a class method, which accumulates object points, or other such sizing metrics. Besides software size, known parametric equations also routinely accept such variables as environmental factors and constraints. Environmental factors such as management experience and programmer competence, and constraint factors such as risk tolerance are likely to impact cost, defects, effort, and schedule.

Although known parametric estimating systems have assisted software managers, these parametric estimating systems have not adequately adapted to changing software development methodologies. For example, military applications may no longer need to be delivered with the intense documentation required by most military software standards. Accordingly, those specifying software for the military may be open to alternative documentation schemes that may save substantial time and money in the military project type. Unfortunately, the known parametric estimating systems generally are not flexible enough to permit the software manager to understand the effect on effort, cost, and defects by selecting an alternative software standard. In a similar manner, modern software deployment may require an accelerated development schedule, or the software to be developed has a limited useful life. Accordingly, it may be useful to understand how alternative software lifecycles could impact resource allocation. Unfortunately, known parametric estimating systems are unable to adequately inform software managers of the resource impact on selecting alternative software lifecycles.

Therefore, there exists a need for a resource estimating system that provides more accurate resource estimates in light of changing software development methodologies and technologies. Further there is the need that a resource estimating system provide additional flexibility for the software manager as compared to known systems.

### SUMMARY

It is therefore an object of the present invention to provide a resource estimating system that more accurately estimates resources likely to being used in a software development project. It is another object of the present invention to provide a resource estimating system that more flexibly adapts to evolving software development requirements, methodologies, and technologies. In order to alleviate to a great extent the disadvantages of known systems and to meet the stated objectives, an adaptable resource estimating system is presented for estimating resources for a software development project.

Briefly, the adaptable resource estimating system operates on a computer system and uses a highly flexible parametric rule. The parametric rule is arranged to receive values, including values relating to each of a software project type, a software lifecycle, and a software standard. More particularly, a user chooses a software project type from a set of available software project types, a software lifecycle from a set of available software lifecycles, and a software standard from a set of available software standards. The chosen project type, lifecycle, and standard may be related or unrelated, and may be changed independent of the others. Responsive to choosing the project type, the lifecycle, and the standard, the adaptable resource estimating system sets values in the parametric rule. The parametric rule executes and estimates are prepared regarding resource utilization for the particular chosen project type, lifecycle, and standard. These estimates are in regard to software effort, software defects, development schedule, and cost. Each time the project, the lifecycle, or the standard are changed, the parametric equation may be reexecuted to illuminate the resource impact of that change. In this regard, the adaptable resource estimating system enables the user to flexibly manipulate the parametric equation by adjusting only the project type parameters, only the software lifecycle parameters, only the software standard parameters, or a combination of the parameters.

Advantageously, the adaptable resource estimating system enables a user, such as a software manager, to flexibly and efficiently understand the resource impact of an individual change to either a project type, a lifecycle, or a standard. For example, the software manager may execute the parametric rule using a particular project type, lifecycle, and standard. To facilitate speeding development, the software manager may desire to use a software standard requiring less documentation. Accordingly, the software manager may leave the project type and lifecycle as defined and modify the software standard to a less stringent standard. When the parametric rule is reexecuted, project resource estimates will be updated reflecting the reduced documentation requirements, including changes in effort, schedule, and cost. The software manager is thereby able to flexibly adjust a project type, a lifecycle, or a standard to efficiently understand the cost and other resource impact of that adjustment. Accordingly, the software manager is able to more effectively and accurately prepare software resource estimates.

### BRIEF DESCRIPTION OF THE DRAWINGS

FIG. 1 is a block diagram showing a software resource estimating system in accordance with the present invention;

FIG. 2 is a general rule for estimating effort for a software development project in accordance with the present invention;

FIG. 3 is a table showing selected project types for use with a software resource estimating system in accordance with the present invention;

FIG. 4 is a table showing selected environmental considerations for use with a software resource estimating system in accordance with the present invention;

FIG. 5 is a table showing selected software lifecycles for use with a software resource estimating system in accordance with the present invention;

FIG. 6 is a table showing selected software standards for use with a software resource estimating system in accordance with the present invention;

FIG. 7 is a block diagram of a software resource estimating system in accordance with the present invention;

FIG. 8 is an example form for inputting Project type, Lifecycle, and Standard into a software resource estimating system in accordance with the present invention;

FIG. 9 is another example form for inputting Project type, Lifecycle, and Standard into a software resource estimating system in accordance with the present invention;

FIG. 10 is an example form for using an Internet point metric to estimate code size in accordance with the present invention;

FIG. 11 is an example form for using a Domino point metric to estimate code size in accordance with the present invention;

FIG. 12 is an example form for inputting environmental considerations into a software resource estimating system in accordance with the present invention;

FIG. 13 is another example form for inputting environmental considerations into a software resource estimating system in accordance with the present invention;

FIG. 14 is an example form for inputting constraints into a software resource estimating system in accordance with the present invention;

FIG. 15 is an example outcome report showing estimated deliverables from a software resource estimating system in accordance with the present invention;

FIG. 16 is an example outcome report showing estimated work product breakdown from a software resource estimating system in accordance with the present invention;

FIG. 17 is an example outcome report showing estimated risks from a software resource estimating system in accordance with the present invention;

FIG. 18 is an example outcome report showing estimated labor from a software resource estimating system in accordance with the present invention;

FIG. 19 is an example outcome report showing estimated maintenance from a software resource estimating system in accordance with the present invention; and

FIG. 20 is a block diagram showing a software resource estimating system in accordance with the present invention using a generic lifecycle template and a generic standard template.

### DETAILED DESCRIPTION

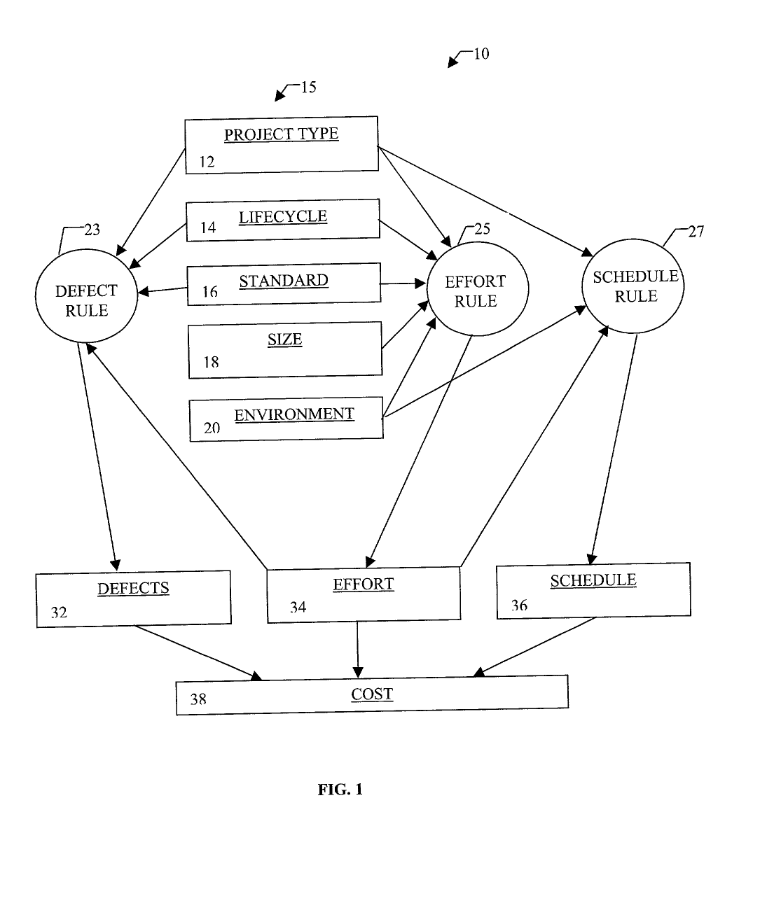

Referring now to FIG. 1, a software resource estimating method 10 is shown. In particular, the estimating method 10 is for use with an adaptable resource estimating system. The adaptable resource estimating system advantageously estimates the resources necessary for a software development program. Such an estimating method 10 is particularly useful for a software professional, such as a software manager. In defining the software development program, the software manager must make decisions as to the methodologies that will be used in developing, deploying, using, and maintaining the resulting software application. The software professional communicates these decisions to the estimating method 10 by entering information through inputs 15. Although estimating method 10 shows five inputs, it will be understood that fewer or more such inputs may be used.

In a preferred implementation, method 10 enables a software manager to interactively adjust any of the inputs 15. In such a manner the software manager is enabled to dynamically determine the resource implication for each change on development resource, such as defects 32, effort 34, schedule 36 and cost 38. In a particularly important feature, the software manager is able to select project type 12, lifecycle 14, and standard 16 independently. In this regard, the software manager is enabled to determine the resource impact of adjusting any one of project type 12, lifecycle 14, or standard 16. Such flexibility enables the software manager to accurately and efficiently use estimating method 10 to manage resource allocation for a software development program.

The estimating method 10 is particularly useful for understanding the resource ramifications of adjusting the software development program. Generally, method 10 incorporates parametric rules for estimating resource utilization. For example method 10 includes an effort rule 25 which reports an estimated effort 34, a schedule rule 27 which reports an estimated schedule 36, and defect rule 23 which reports estimated defects 32. Cost 38 may also be derived from estimating method 10.

In using estimating method 10, a software manager enters input information into the inputs 15. More particularly, the software manager enters a project type 12, a software lifecycle 14, a software standard 16, an estimated code size 18, and environment conditions 20. It will be appreciated that parametric rules may also incorporate other inputs, such as constraints. By completing each input, the software manager causes the method 10 to select and pass parameter values to one or more of the rules. For example when a particular project type is selected, values are selected for parameters and these values are passed to the effort rule 25, the defect rule 23, and schedule rule 27. It will be appreciated that the values or set of values sent to each of the rules may be different.

Once all inputs 15 have been set or left in a default condition, then method 10 proceeds to execute effort rule 25. In this regard, effort rule 25 receives values for variables from project type 12, lifecycle 14, standard 16, size 18, and environment 20. The parametric equation embodied in effort rule 25 uses the values and generates effort 34, generally expressed in person months of effort. Once effort 34 has been calculated, then defect rule 23 and schedule rule 27 may be executed.

Defect rule 23 receives values for variables from project type 23, lifecycle 14, standard 16, and the estimated effort 34. The parametric equation embodied in defect rule 23 uses the values and generates defects 32, generally expressed in defects found during the first year of software operation. Schedule rule 27 receives values for variables from project type 12, environment 20, and the estimated effort 34. The parametric equation embodied in schedule rule 27 uses the values and generates schedule 36, generally expressed in calendar months. Defects 32, effort 34, and schedule 36 may be used to estimate an overall cost 38 for the software development program. It will be appreciated that although cost 38 is shown in FIG. 1 as being derived from defects 32, effort 34, in schedule 36, cost 38 may be alternatively determined.

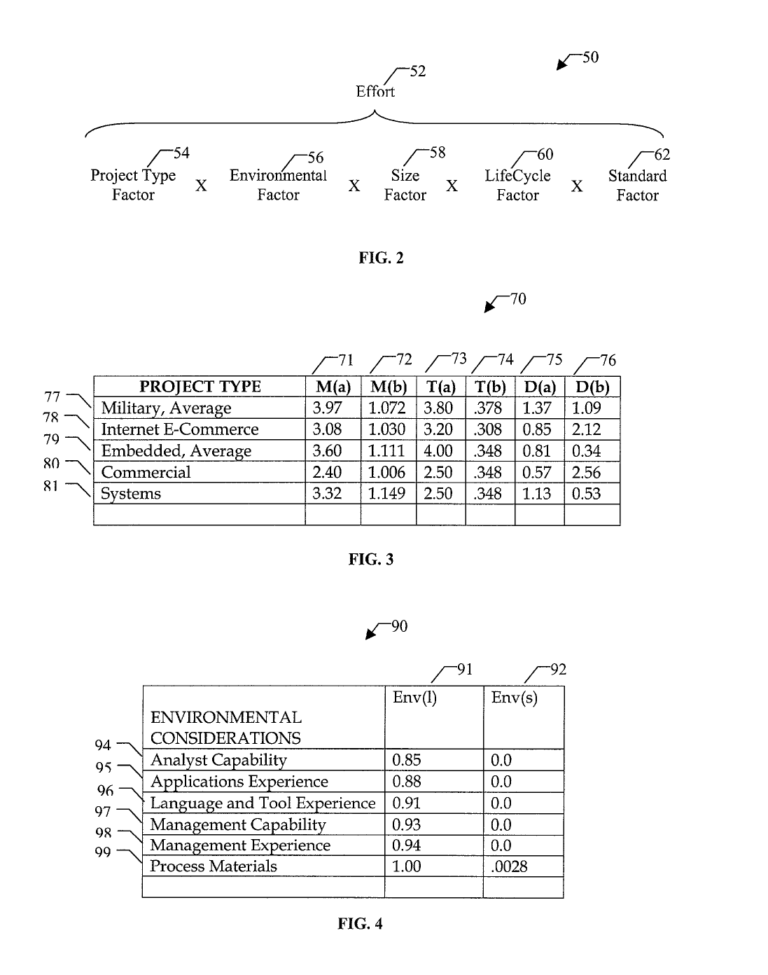

Referring now to FIG. 2, a general form for effort rule 50 is illustrated. Effort 52 is related to project type factor 54, environmental factor 56, size factor 58, lifecycle factor 60, and standard factor 62. Importantly, effort 52 is determined based on parameter values for project type, lifecycle, and standard. Thus, project type, lifecycle, and standard must be defined prior to calculating 15 effort 52. A key to implementing effort rule 50 is the understanding that lifecycle factor 60 and standard factor 62 may be independently adjusted. Stated another way, a change to lifecycle factor 60 or standard factor 62 does not require a change to the other factor. Further, both lifecycle factor 60 and standard factor 62 have a linear effect on effort 52. Realizing that lifecycle factor 60 and standard 20 factor 62 operated independently and linearly as compared to project type factor 54 enables the estimating method great flexibility in determining effort 52.

As generally described above, defining one of the inputs 15 causes the estimating method to assign values to variables in at least one of the parametric rules. It will be appreciated the parametric rules may be embodied in several alternate forms. In this regard, the precise values to be used in the parametric equations is dependent on the specific form of the equation used. Also, it will be appreciated that parametric equations may be developed that use fewer or more variables than the equations described regarding the estimating method 10. Accordingly, a general arrangement for assigning parameter values is described below with reference to FIGS. 3-6, and then specific rules are discussed.

Referring now to FIG. 3, project type table 70 is shown. In general, selecting a project type defines the overall scope of the software development project. Often, the project type is related to the industry for which a software application is being developed. For example, a military project type would be assigned to a typical software application written for the Department of Defense. A telecom project type may be assigned for switching software for communications company, while an Internet e-commerce project type may be assigned to dotcom company. Each of these project types is generally associated with an overall degree of complexity and overall acceptable degree of risk. For example, software applications for military deployment typically have harsh quality requirements, while the software requirements for a new dotcom company may be far less stringent.

Table 70 illustrates several project types, such as project type military, average 77, Internet e-commerce 78, embedded, average 79, commercial 80, and systems 81. It will be appreciated that many other project types may be incorporated into an estimating system. Each project type is associated with several parameters and values for use in the rules of the estimating method. For example, the values M(a)71 and M(b) are used in an effort rule, values T(a) and T(b) are used in a schedule rule, and values D(a) and D(b) are used in a defects rule. Use of these values in the respective rules will be described later in more detail.

Values in table 70 were derived from analysis of thousands of completed software development projects. The mathematical approaches to calculating the values for M(a), M(b), T(a), T(b), and D(b) are documented in the popular literature and are outside the scope of this description. D(a) is calculated as Life * Std where Life and Std are as defined below. The appropriate value for Life and Std are selected based on the normal, or most common, lifecycle and standard for each project type.

Referring now to FIG. 4, an environmental considerations table 90 is shown. In general, environmental considerations are useful for making subjective adjustments to estimate resource usage. For example, the experience level of management will affect schedule, defects, and effort. Therefore an environmental value for management experience may be adjusted depending on the relative risk associated with the experience of the management team. Many other environmental variables may be identified and valued. Depending on the specific rule used, an overall environmental factor is determined based on an aggregation of all environmental factors input into the system. It will be appreciated that each specific rule may incorporate environmental values in a different manner. For example, some rules may requirement that a product be used, while another rule may require a simple summing of selected environmental variables.

Table 90 specifically lists several environmental conditions, such as analyst capability 94, applications experience 95, language experience 96, management capability 97, management experience 98, and process maturity 99. It will be appreciated that many other environmental considerations may be included in a system for estimating software resource. Each of the environmental considerations is associated with environmental values Env(1) and Env(s). The values shown in this table represent values for a rating of high, or one level above nominal. It will be appreciated that environmental variables may have multiple potential ratings with a value associated with each rating. These values for the environmental variables are useful in the effort rule and the schedule rule of the estimating method. Use of these values in the respective rules will be described later in more detail.

Appropriate values for environmental variables are determined by researchers in the industry using a combination of mathematical analysis of existing projects and the Delphi technique applied to industry experts. These approaches are documented in the popular literature and are outside the scope of this description.

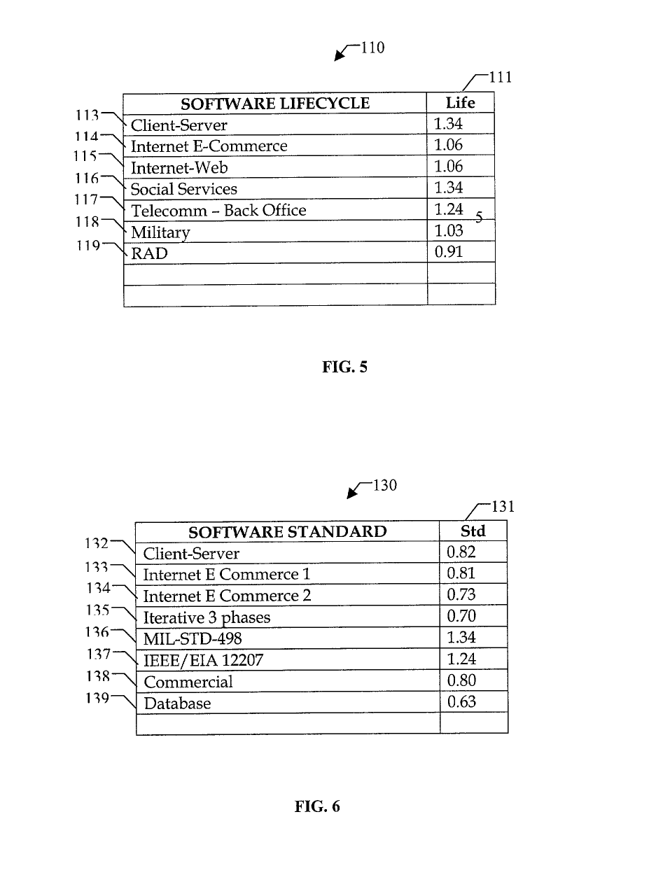

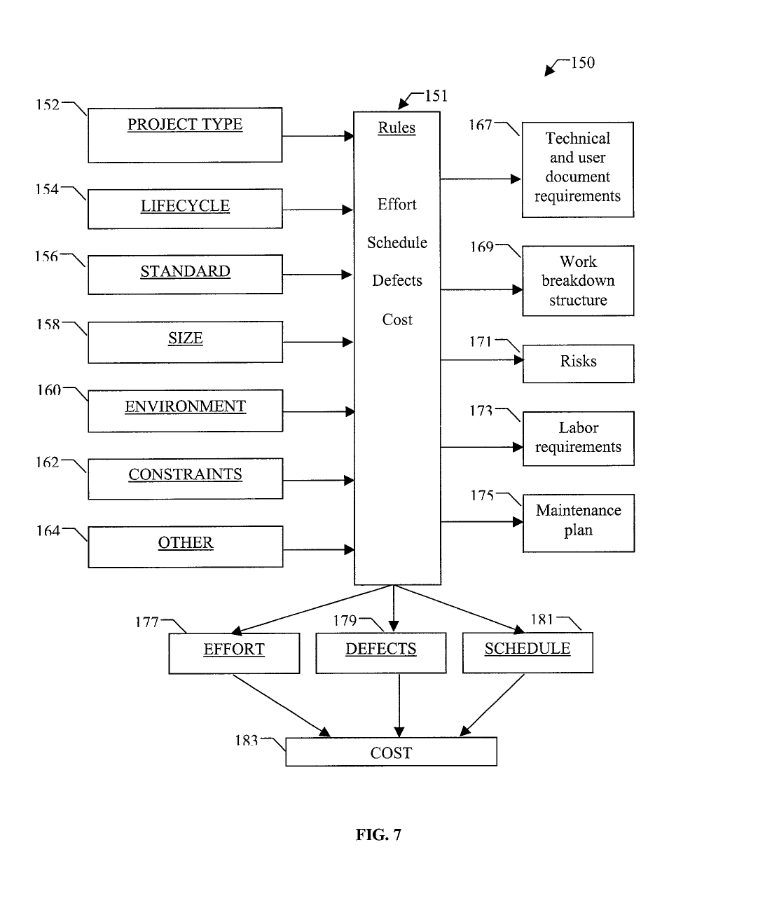

Referring now to FIG. 5 a software lifecycle table 110 is shown. Generally, a software lifecycle is used to generate a specific work breakdown structure that may be reported as a list chronologically showing tasks or actions required in the software developer project. Alternatively, the work break down structure may be viewed as a Gantt chart or using another project management tool. Each software lifecycle is related to a specific work break down structure. For example, a military work break down structure would contain several tasks related to approval by Department of Defense, many documentation activities, substantial testing, training for military users, and long-term maintenance scheduling. In contrast, an Internet software lifecycle may still contain client approval tasks, but is likely to have more limited documentation and training requirements, and the life of the software will likely be much shorter.

Table 110 lists several software lifecycles, such as client/server 113, Internet e-commerce 114, Internet Web 115, social services 116, Telecom Back Office 117, military 118, and RAD (Rapid Application Development) 119. It will be appreciated that many other software lifecycles may be defined in a system for estimating software resource. Each software lifecycle is associated with a lifecycle value Life 111. The value for the lifecycle variable is useful in the effort rule and the defect rule. Also, since the schedule rule is dependent on the effort rule, indirectly the lifecycle value affects the schedule rule. Use of this value in the respective rules will be described later in more detail.

Lifecycle values were determined through more than 2 years of research into the impact on parametric models of various lifecycles. This work included identifying whether the impact was linear or non-linear, isolating any potential correlation between this impact and other variables, and extensive analysis of projects completed using different software lifecycles. The resulting information enables the estimating method 10 to estimate resource utilization with an accuracy and flexibility unavailable in conventional systems.

Referring now to FIG. 6, a software standard table 130 a shown.

Generally, a software standard defines the documents and other deliverables for a particular client. For example, many military software applications require documentation compliant to a military standard called MIL-STD-498. This standard provides rigorous instructions and directions on how a software developer must provide development, deployment, training, and maintenance documentation for a military software application. Other software standards may not be as rigorous, for example, a software standard for web gaming.

Table 130 lists several software standards such as client/server 132, Internet e-commerce 1 133, Internet e-commerce 2,134 interactive 3 phases 135, MIL-STD-498 136, IEEE/EIA 12207137, commercial 138, and RAD 139. It will be appreciated that many other software standards may be defined in a system for estimating software resource. Each software standard is associated with a standard value Std 131. The value for the standard variable is useful in the effort rule and the defect rule. Also, since the schedule rule is dependent on effort rule, indirectly the standard value affects the schedule rule. Use of this value in the respective rules would be described later in more detail

Software Standard values were determined through more than 2 years of research into the impact on parametric models of various standards. This work included identifying whether the impact was linear or non-linear, isolating any potential correlation between this impact and other variables, and extensive analysis of projects completed using different software standards. The resulting information enables the estimating method 10 to estimate resource utilization with an accuracy and flexibility unavailable in conventional systems.

Although the rules, such as the effort rule, the defects rule, and the schedule rule may be implemented in various forms, the specific rules used in estimating method 10 are described below.

The effort rule may be generally defined as:

Effort=ΠEnv(l)*M(a)*Std*KSLOC^{M(b)+ΣEvn(s)},

where

“Effort” is an estimate of resource use expressed in person-months

“Env(l)” is a linear value for environmental considerations (e.g. FIG. 4)

“Env(s)” is a scaling value for environmental considerations (e.g. FIG. 4)

“M(a)” is a linear value for project type (e.g. FIG. 3)

“M(b)” is a scaling value for project type (e.g. FIG. 3)

“Life” is a linear value for the selected software lifecycle (e.g. FIG. 5)

“Std” is a linear value for the selected software standard (e.g. FIG. 6)

“KSLOC” is a value for the estimated lines of code (e.g. from a sizing metric)

The schedule rule may be generally defined as:

Schedule=T(a)* Effort ^{T(}b)+(Σenv(s)/5)

where

“Schedule” is an estimate of resource allocation expressed in calendar-months

“T(a)” is a linear value for project type (e.g. FIG. 3)

“T(b)” is a scaling value for project type (e.g. FIG. 3)

“Effort” is an estimate of resource used that is derived from the effort rule

“Env(s)” is a scaling value for environmental considerations (e.g. FIG. 4)

The defects rule may be generally defined as:

Defects=D(a)*D(b)*Effort*(1/Life)*(1/Std),

where

“Defects” is an estimate of software defects expressed in defects per year

“D(a)” is an adjustment factor for the typical lifecycle and standard associated with this project type (e.g. FIG. 3)

“D(b)” is the typical defects that will be found in year 1 following software completion (e.g. FIG. 3)

“Effort” is an estimate of resource used that is derived from the effort rule

“Life” is a linear value for the selected software lifecycle (e.g. FIG. 5)

“Std” is a linear value for the selected software standard (e.g. FIG. 6)

The cost rule may be generally defined as:

$$C o s t = {\sum }_{AllLaborCategories} ( L a b o r C o s t * {\sum }_{AllTasks} ( T a s k \% * L a b o r C a t \% * Effort ) ) , w h e r e$$

“Cost” is an estimate of the development cost in dollars

“LaborCost” is the hourly cost for each labor category

“Task” is the percent of the total effort allocated to this task for this project

“LaborCat” is the percent of the task's effort that will be allocated to this labor category

“Effort” is an estimate of resource used that is derived from the effort rule

Referring now to FIG. 7, another estimating method 150 is shown. The estimating method 150 is similar to estimating method 10, so only differences will be described in detail. The estimating method 150 has rules 151. The rules 151 include an effort rule, a defect rule, and a schedule rule, as generally previously described. It will be appreciated that other rules may be added as required for specific applications. Preferably, each of the rules 151 includes a parametric equation or algorithm. It will be appreciated that the inventive aspect of estimating method 10 and estimating method 150 may be used in conjunction with other rules.

Rules 151, which include equations with variables as previously described, receive values for these variables from project type 152, lifecycle 154, standard 156, size 158, environment 116, constraints 162, and possibly other inputs 164. These inputs are accepted by rules 151 and the rules 151 generate an estimate of effort 177, an estimate of defects 179, and an estimate of schedule 181. Further, rules 151 may either directly or indirectly determine a cost estimate 183. Also, rules 151 and other modules in the estimating software system generate other reports and output, such as technical and end-user document requirements 167. A work break down structure 169 showing specific project tasks is also generated. Risks 171, labor requirements 173, and a maintenance plan 175 are also common outputs from an estimating method such as estimating method 150. It will be appreciated that the information resident in the estimating method 150 and generated by the rules 151 may be useful in creating several other reports.

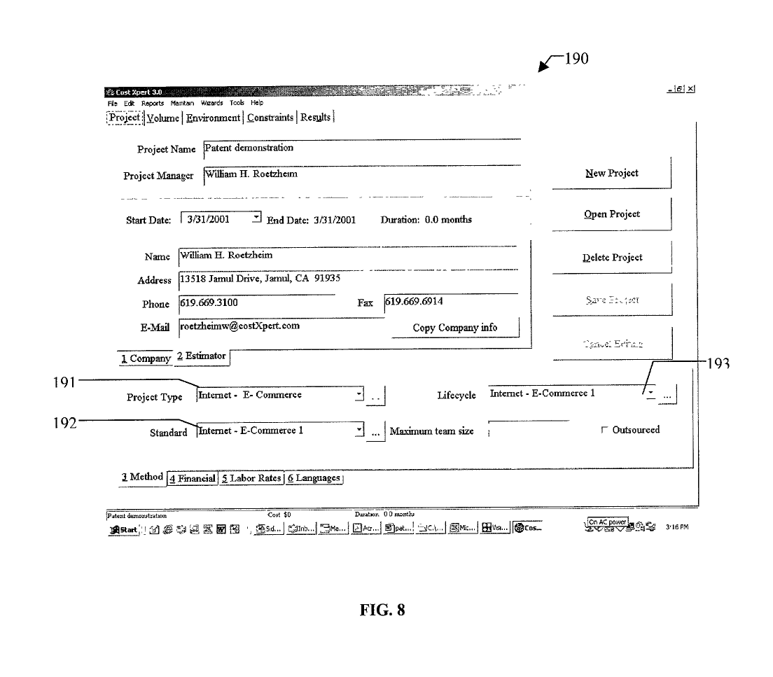

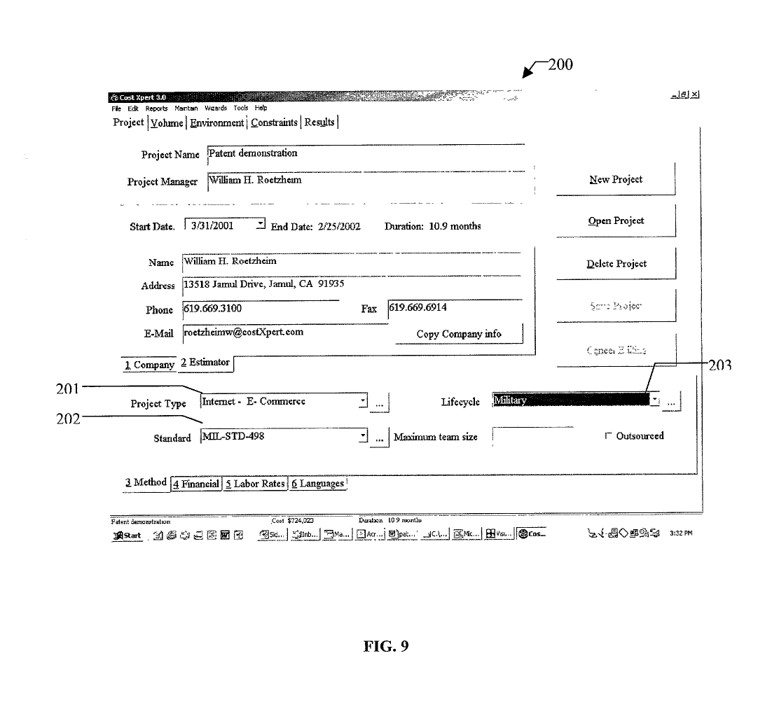

A prototype adaptable resource estimating system has been developed. This prototype adaptable resource estimating system incorporates an estimating method similar to estimating method 10. FIGS. 8-19 illustrate example screens from the prototype system. It will be appreciated that many alternatives exist for requesting input from a user and for presenting outputs and reports.

Referring now to FIG. 8, an example form 190 for inputting project type 191, lifecycle 193, and standard 192 into the software resource estimating system is shown. As illustrated in FIG. 8, each of these inputs uses a pull down selection box for selecting the specific information to be input into the estimating method. In FIG. 8, the project type, lifecycle, and standard are all selected to be Internet e-commerce. It is likely that a software manager may begin estimating software resource requirements by selecting the type, lifecycle, and standard to all be the same. Then, as reports and outputs are reviewed, the software manager or client may suggest alternatives.

For example, FIG. 9 shows another input form 200 similar to input form 190. Although project type 200 is still selected to be Internet e-commerce, the lifecycle 203 is selected to be military, while the standard 202 is selected to be MIL-STD-498. Accordingly, both the lifecycle and the standard are selected to comply with strict military requirements. Such a combination of inputs may be desirable, for example, if the Army is requesting a combat support intranet. Importantly, even though the project type is still defined as a generally commercial type, the added burden for having a military lifecycle and a MIL-STD document requirement may dramatically impact effort, schedule, defects, and overall cost. Indeed, with the flexibility of the present estimating method, the software manager may better understand the impact of the lifecycle change independently and the standard change independently. Such flexibility allows the software manager to make adjustments to the software development project to more efficiently utilize available resources.

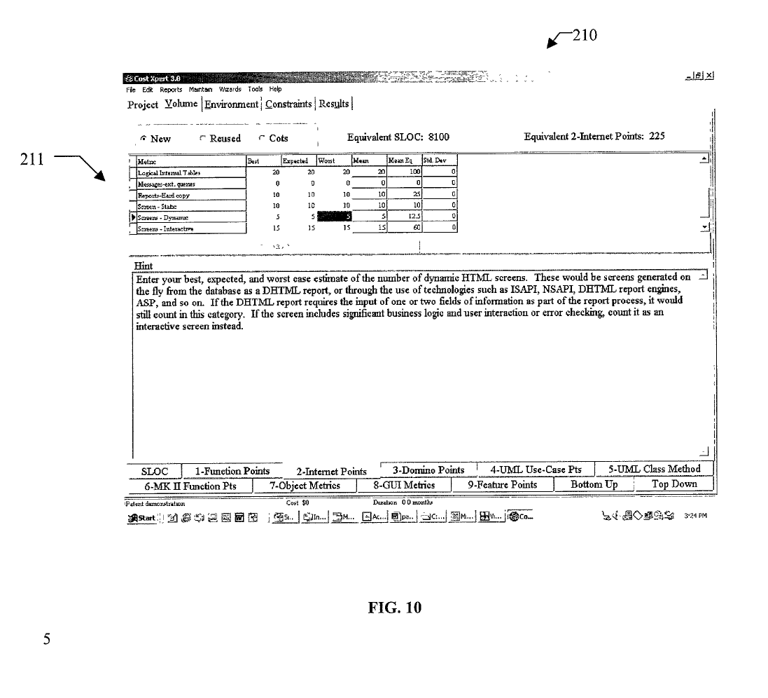

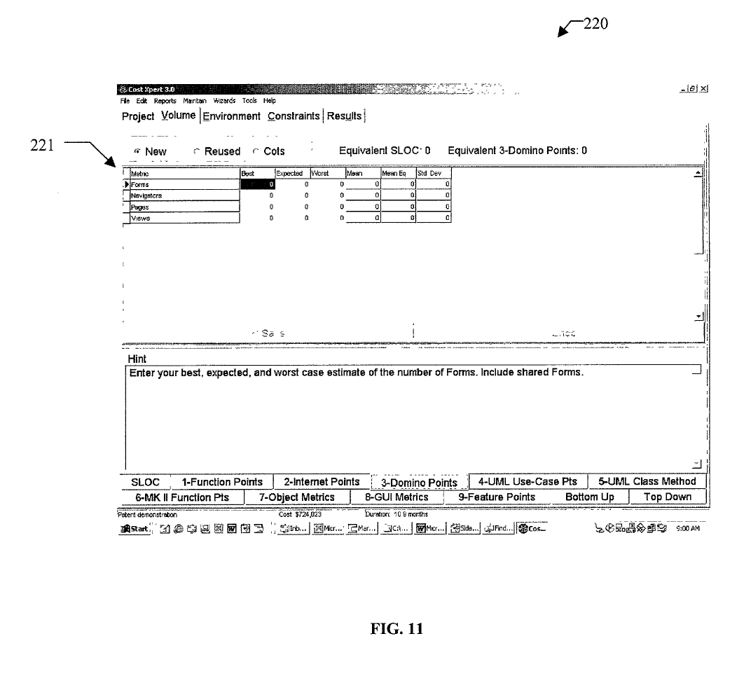

FIG. 10 shows an example of a sizing metric 210. More specifically, sizing metric 210 uses Internet points to estimate a code size. For example, a software manager enters information into input section 211, such as the number of logical internal tables, the number of external queries, the number of hard copy reports, the number of static screens, the number of dynamic screens, and the number of interactive screens. It will be appreciated that other internet sizing points may be accepted for input. Based on the inputs in section 211, the estimating method estimates a code size, which is typically expressed in thousands of lines of code or KSLOCs. The KLOC value is useful in the parametric rules, which will be described in more detail later.

FIG. 11 shows another example of a sizing metric 220. More specifically, sizing metric 220 uses Domino points to estimate a code size. Domino is a particular software language developed by IBM/Lotus especially useful for developing workflow and form oriented applications. Accordingly, an increasing number of software development projects are incorporating at least some aspects developed in Domino. In input section 221, a software manager inputs sizing points such as forms, navigators, pages, and views. It will be appreciated that other sizing points may be accepted for input. Based on the inputs in section 221, the estimating method estimates a code size, which is typically expressed in thousands of lines of code or KSLOCs. The KSLOC value is useful in the parametric rules, which will be described in more detail later.

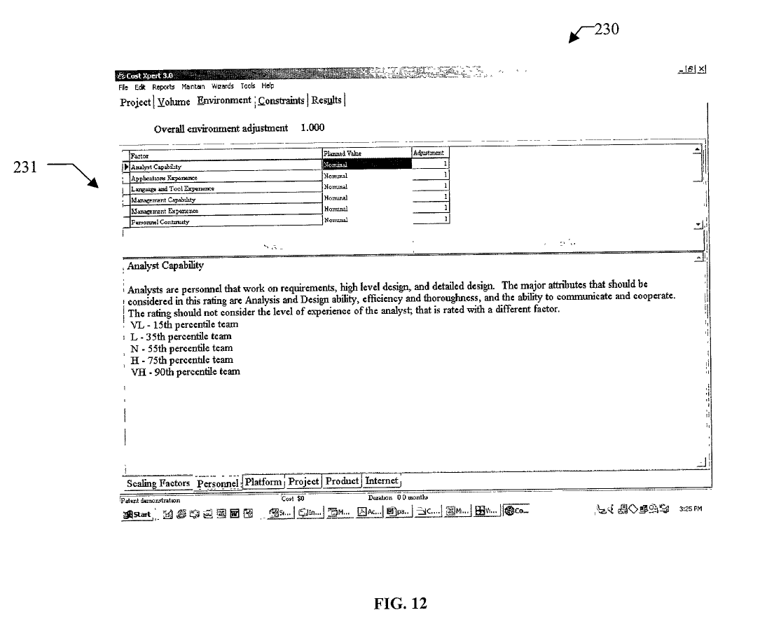

FIG. 12 is an example form 230 for inputting environmental considerations into a software resource estimating system. Form 230 includes an input area 231 where a software manager is able to evaluate subjective qualities for the software development project. For example, the software manager is asked to adjust the software development project in light of analyst capability, applications experience, language experience, management capability, management experience, and personnel continuity. It will be appreciated that many other environmental considerations may be used.

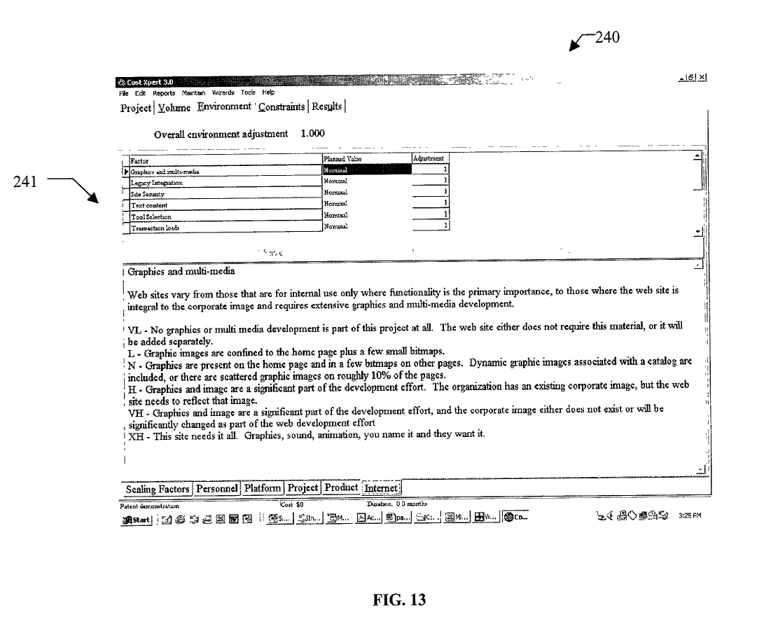

Referring now to FIG. 13, another input form 240 for inputting environmental considerations is shown. More specifically form 240 is used to input environmental considerations specific to Internet development. In input area 241 a software manager is allowed to subjectively evaluate the software development project in such categories as graphics and multimedia, legacy integration, site security, text content, tool selection, and transition tools. It will be appreciated that many other Internet environmental considerations may be used. Each of these Internet environmental considerations could positively or negatively affect estimates for resources depending on whether the software manager rates a particular environmental condition as particularly favorable or as particularly negative.

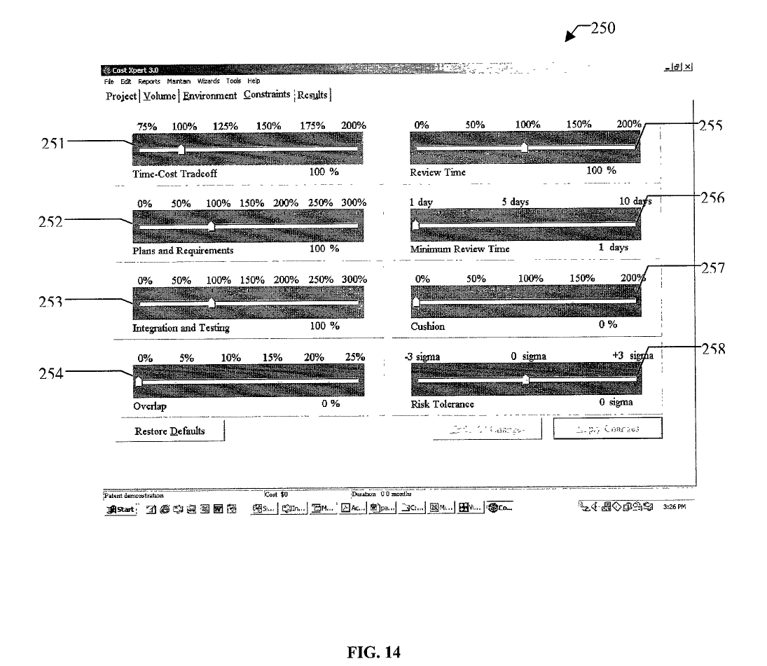

FIG. 14 shows an example form 215 for inputting constraints into a software resource estimating system. Form 250 allows a software manager to subjectively evaluate specific constraints for a particular software development project. For example this particular estimating method defines constraints as: time-cost trade-off 251, plans and requirements 252, integration testing 253, overlap 254, reviewed time 255, minimum reviewed time 256, cushion 257, and risk tolerance 258.

Constraints, much like environmental conditions, present a subjective opinion of a software manager regarding a specific software development project. For example, a software manager may understand that the software application has not been clearly defined by the client. Accordingly, the software manager may adjust the plans and requirements 252 constraint to a higher percentage, thereby increasing allotted time and resource for the planning process. It will be appreciated that many other constraints may be used in an estimating method.

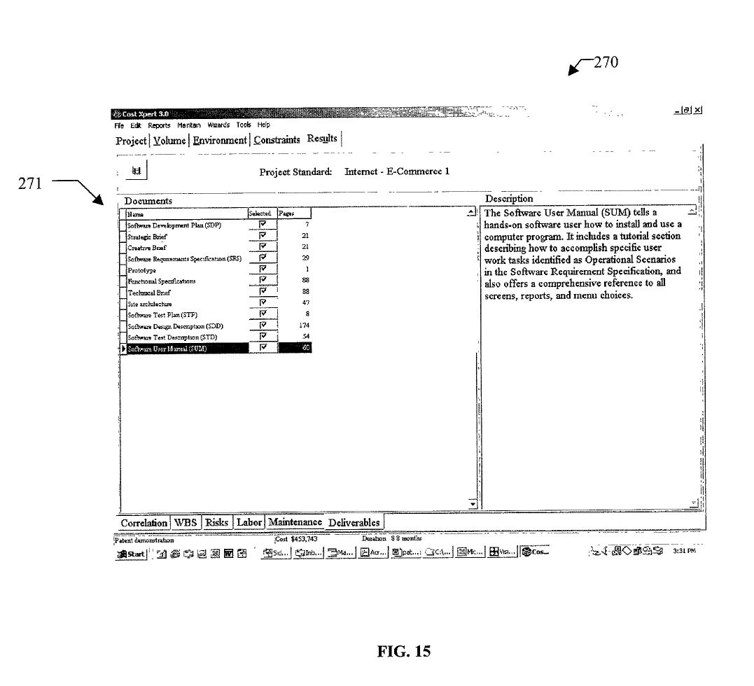

FIG. 15 is an example outcome report 270 showing deliverables to the client. More specifically, deliverable list 271 shows a list of documents and other deliverables for a particular project standard. Of course, choosing another project standard is likely to change the list of deliverables, and is also likely to impact other resource estimates such as scheduled, cost, and effort.

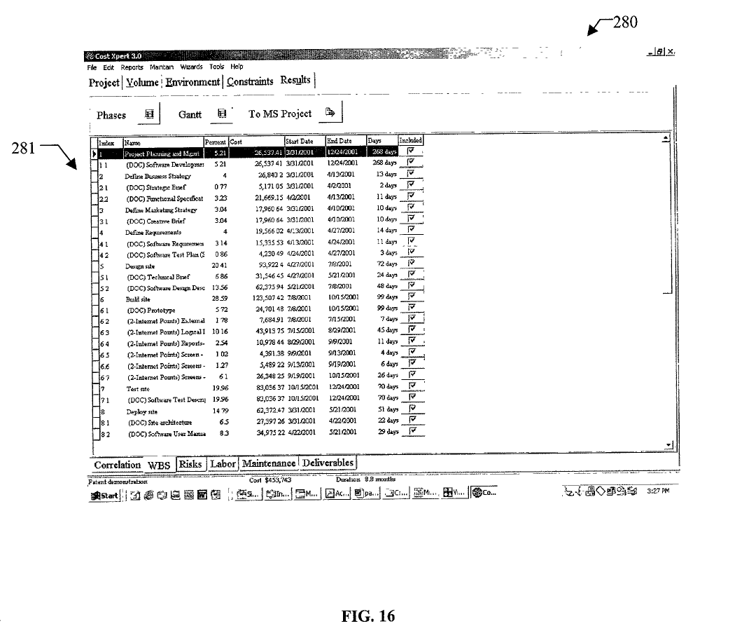

FIG. 16 is an example outcome report 280 showing a work breakdown structure. The work breakdown structure 281 is a detailed list of tasks or activities to be accomplished during the software developer project. More particularly, the work breakdown structure 281 is associated with a particular software lifecycle. By selecting an alternative software lifecycle, the work breakdown structure is likely to change. Such change is also likely to impact other resource estimates such as schedule, cost, and effort.

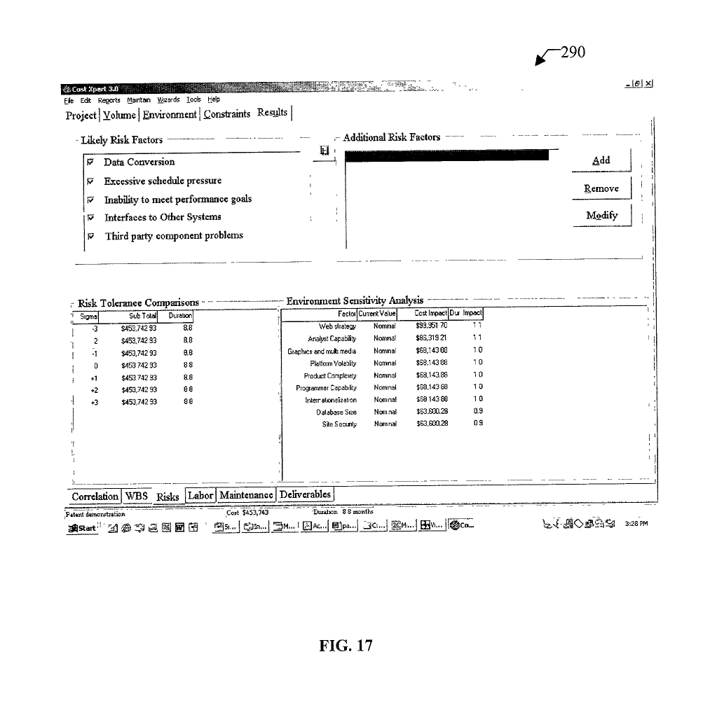

FIG. 17 is an example outcome report 290 showing estimated risks in the software developer project. Risks, and the cost of risks, are highly dependent on the risk tolerance for a particular project type and risk tolerance for particular client. It will be appreciated that risk may being presented in alternative ways.

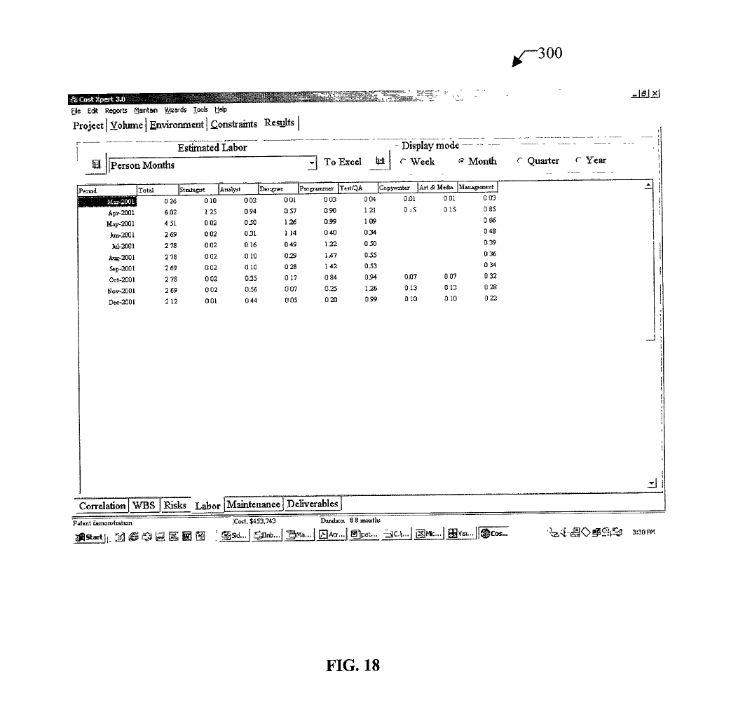

Referring now to FIG. 18, an example output report 300 is shown. Report 300 is a report showing estimated labor in person months for a particular software development project. A change to project type, software lifecycle, or software standard is likely to have an impact on labor or other resource required in the software development project. It will be appreciated that labor and other effort may be displayed to a user in alternative ways.

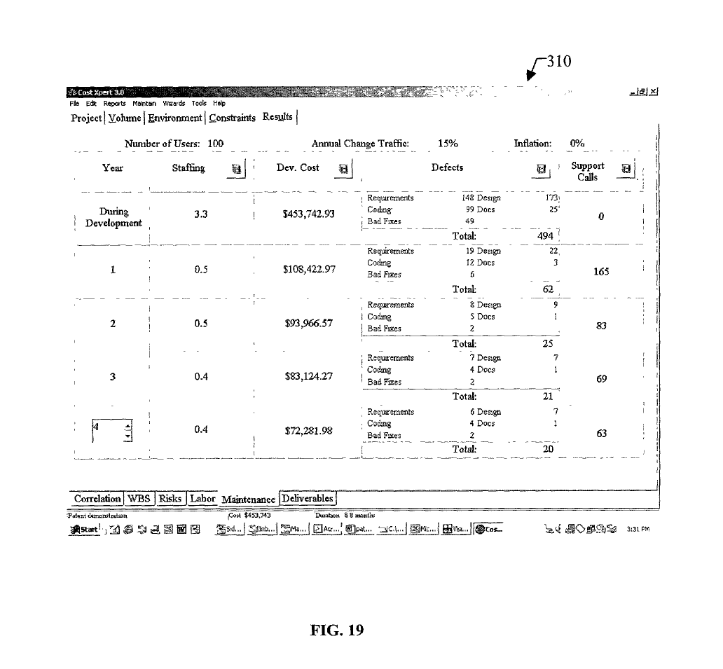

FIG. 19 generally illustrates an outcome report 310 showing estimated required maintenance during the lifecycle of the software project. The report shows estimated maintenance costs during development and in follow-up years. Further, report 310 estimates number of defects in the software each year. For example, in the first year after development 62 defects are expected, while in the second year only 25 defects are expected. It will be appreciated that maintenance and defect information may be displayed in alternative ways.

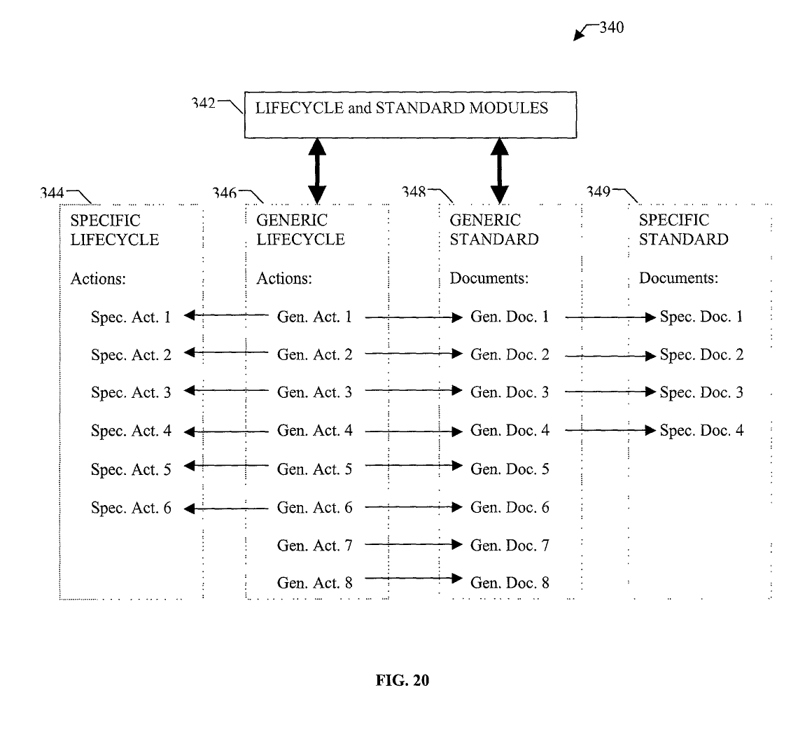

FIG. 20 is a block diagram showing a portion 340 of a software resource estimating system. More particularly, FIG. 20 describes a highly efficient way to manage lifecycles and standards in a software resource estimating system. The estimating system has a lifecycle and standard module 342 that manages lifecycles and standards. Accordingly, the estimating system incorporates a consistent interface to lifecycles and standards. Such consistency facilitates efficiently adding and modifying lifecycles and standards. In this regard, the estimating system may be easily modified to adapt to changing software development methodologies, technologies, and requirements. It will be appreciated that the module 342 may be designed in alternate forms.

To facilitate ease of adding new lifecycles and standards, the lifecycle and standard module 242 interfaces with a generic lifecycle 346 and a generic standard 348. The generic lifecycle 346 contains several generic actions. At least some of these generic actions are related to required generic documents in the generic standard 348. Therefore, when a new specific lifecycle 344 is entered into the system, the specific lifecycle need only been mapped to the generic lifecycle 346. Accordingly, each specific lifecycle does not have to be individually mapped to individual project types or specific standards. In a similar manner when a new specific standard 349 is added to the system, the specific standard 349 need only to be mapped to the generic standard 348. Accordingly, adding new lifecycles and new standards is accomplished in an efficient manner.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A method of estimating an outcome for a software development project, comprising:
selecting a parametric rule having a plurality of variables;
choosing a project type, a lifecycle, and a standard for the software development project;
assigning a type factor responsive to choosing the project type;
assigning a lifecycle factor responsive to choosing the lifecycle;
assigning a standard factor responsive to choosing the standard;
using the type factor, the lifecycle factor, and the standard factor as variables in the parametric rule; and
generating the outcome.

2. The method according to claim 1 wherein the outcome is a software effort estimate for the software development project.

3. The method according to claim 1 wherein the outcome is a software defect report for the software development project.

4. The method according to claim 1 wherein the outcome is a software development schedule for the software development project.

5. The method according to claim 1 wherein the outcome is a estimated cost for the software development project.

6. The method according to claim 1 wherein assigning the lifecycle factor includes extracting the lifecycle factor from a look-up table.

7. The method according to claim 1 wherein assigning the standard factor includes extracting the standard factor from a look-up table.

8. The method according to claim 1 wherein using the lifecycle factor includes using the lifecycle factor as a linear variable in the parametric rule.

9. The method according to claim 1 wherein using the standard factor includes using the standard factor as a linear variable in the parametric rule.

10. The method according to claim 1 wherein using the lifecycle factor includes using the an inverse of the lifecycle factor as a linear variable in the parametric rule.

11. The method according to claim 1 wherein using the standard factor includes using an inverse of the standard factor as a linear variable in the parametric rule.

12. The method according to claim 1 wherein the parametric rule further uses a size factor indicative of the number of lines of code to be written in the software development project.

13. The method according to claim 12 wherein the size factor is generated by using an internet point metric.

14. The method according to claim 12 wherein the size factor is generated by using Domino point metric.

15. The method according to claim 1 wherein the parametric rule further uses an environmental factor indicative of environmental conditions specific to the software development project.

16. The method according to claim 1 further including using a generic lifecycle template to generate a work product breakdown.

17. The method according to claim 16, wherein the chosen lifecycle is mapped to the generic lifecycle template.

18. The method according to claim 1 further including using a generic standard template to generate a document requirement report.

19. The method according to claim 16, wherein the chosen standard is mapped to the generic standard template.

20. The method according to claim 1 wherein the parametric rule uses the type factor, the lifecycle factor, the standard factor, an environment factor, and a size element.

21. The method according to claim 20 wherein the parametric rule is used to determine an effort, and has the general form of “EFFORT=TYPE FACTOR*LIFECYCLE FACTOR*STANDARD FACTOR*ENVIRONMENT FACTOR*SIZE ELEMENT.”

22. The method according to claim 21 wherein the parametric rule is in the form of “EFFORT=ΣEnv(l)*M(a)*Life*Std*KSLOC^{M(b)+ΣEnv(s)}”.

23. The method according to claim 21 further including using a defect parametric rule and a defect factor associated with the project type, the defect parametric rule having the form of “DEFECT=DEFECT FACTOR*EFFORT*(1/LIFECYCLE FACTOR)*(1/STANDARD FACTOR)”.

24. The method according to claim 21 further including using a schedule parametric rule and a schedule factor associated with the project type, the schedule parametric rule having the form of “Schedule=T(a)*Effort^{T(b)+(Σenv(s)/5})”.
